(19) United States
(12) Patent Application Publication
(10) Pub. No.: US 2008/0177641 A1
(43) Pub. Date: Jul. 24, 2008

(54) Method and system for online cooperative shopping

(76) Inventors: Edward Herniak, Amherst (CA); Julia Herniak, Amherst (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 12/010,023

(22) Filed: Jan. 18, 2008

Related U.S. Application Data
(60) Provisional application No. 60/881,166, filed on Jan. 19, 2007.

(51) Int. Cl. G06Q 30/00

(52) U.S. Cl. 705/27

(57) ABSTRACT

A method of providing a collaborative shopping experience is provided to a shopper accessing an on-line shopping experience. Whilst it is extremely convenient to order products and services over the World Wide Web this is not the social activity physically shopping with friends and family provides. Accordingly the invention provides an online shopping experience wherein a group of collaborative shoppers may provide suggestions, modifications, help and advice to each other within the online shopping activity. The online shopping experience may be provided by a single store or may multiple stores collaborating themselves to provide essentially an online mall with browsing, reserving, changing and finally buying. Advantageously the method allows online retailers to maintain relationships to their online customers as an online store assistant may be brought into collaborative group upon request. Further the introduction of avatars allows the buying experience to become visually more appropriate to the collaborative shopper.

This application claims the benefit of U.S. Provisional Application No. 60/881,166, filed on Jan. 19, 2007, the entire content of which is incorporated herein by reference.

### FIELD OF THE INVENTION

The invention relates generally to data communications and more particularly to a use of data communications to facilitate a shopping experience.

### BACKGROUND

With the advent of on-line shopping, it is becoming extremely convenient to order products and services over the World Wide Web. Unfortunately, Internet shopping, though extremely convenient, is not a social activity. In contrast, shopping is typically a social activity. Advantageously, on-line shopping is absent of pushy sales people and business owners. Conversely, it is also absent of helpful insights and feedback.

On-line shopping is now a very big business in North America and worldwide. In order to attract more shoppers, enhancing a quality of the online shopping experience is mandatory.

It would be advantageous to provide a social context to on-line shopping.

### SUMMARY OF THE INVENTION

In accordance with the invention there is provided a method comprising:
providing at least a first shopper and a second shopper, the first and second shoppers comprising two cooperative shoppers of a plurality of cooperative shoppers,
selecting within a virtual environment a first item of a plurality of items by the first shopper for at least one of the first shopper and second shopper,
providing an indication of the first item to each of the first shopper and second shopper,
evaluating the first item by the second shopper,
selecting a second item of the plurality of items within the virtual environment in dependence upon at least the first item and the evaluation, the second item selected by the second shopper; and
providing an indication of the second item to each of the first shopper and second shopper.

### BRIEF DESCRIPTION

The invention will now be described with reference to the attached drawings in which:

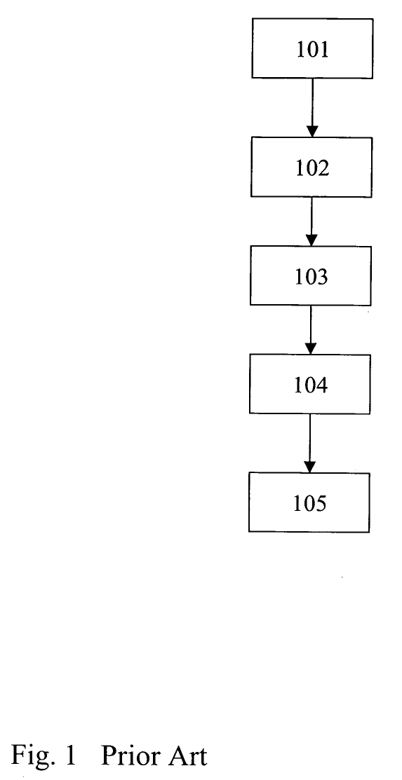

FIG. 1 is a simplified flow diagram of an embodiment of the invention for online shopping;

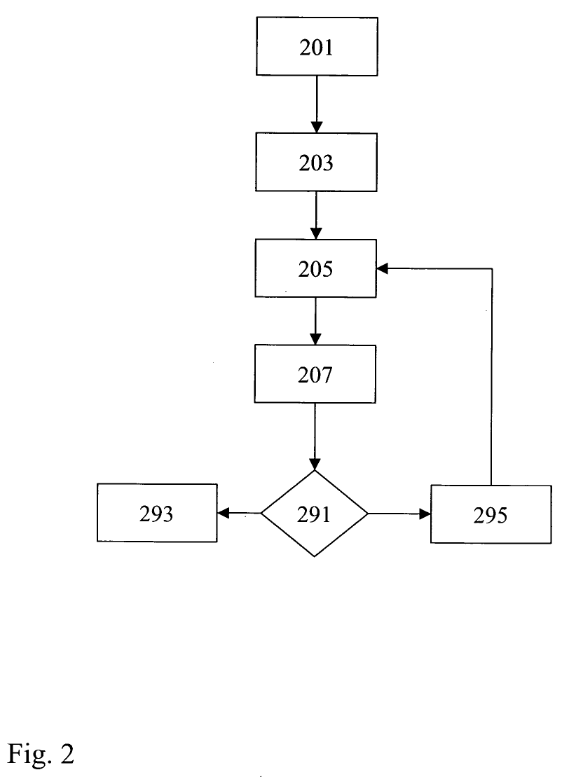

FIG. 2 is a simplified flow diagram of an embodiment of the invention for online shopping;

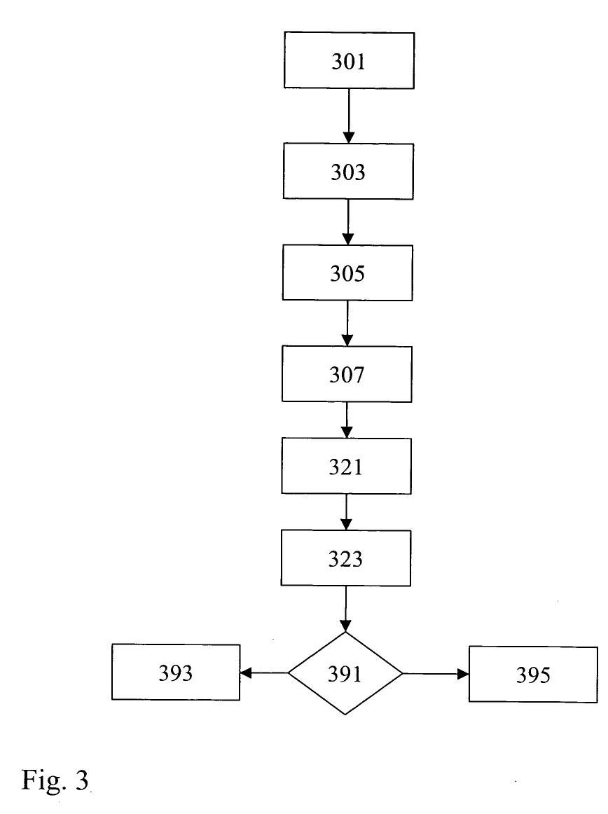

FIG. 3 is a simplified flow diagram of an embodiment of the invention for online shopping;

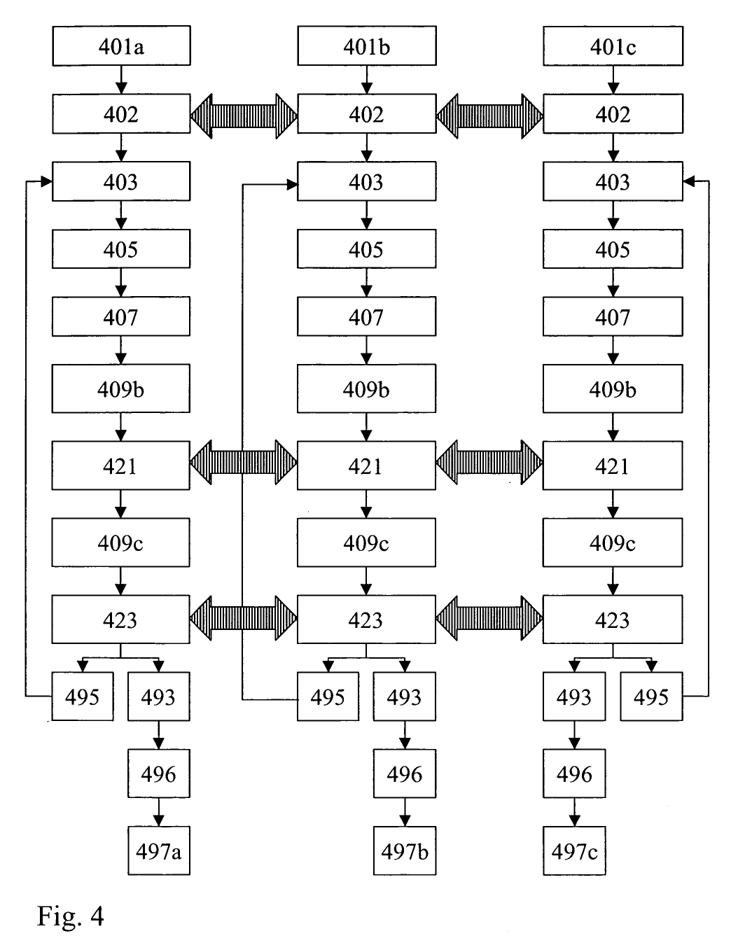

FIG. 4 is a simplified flow diagram of an embodiment of the invention for online shopping;

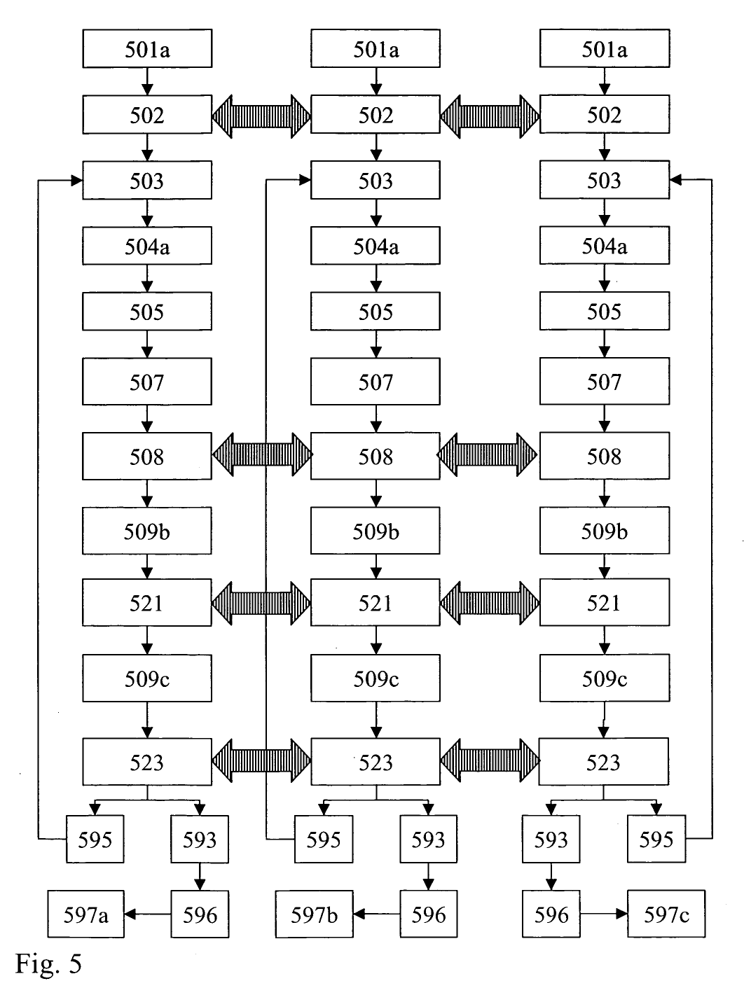

FIG. 5 is a simplified flow diagram of an embodiment of the invention for online shopping;

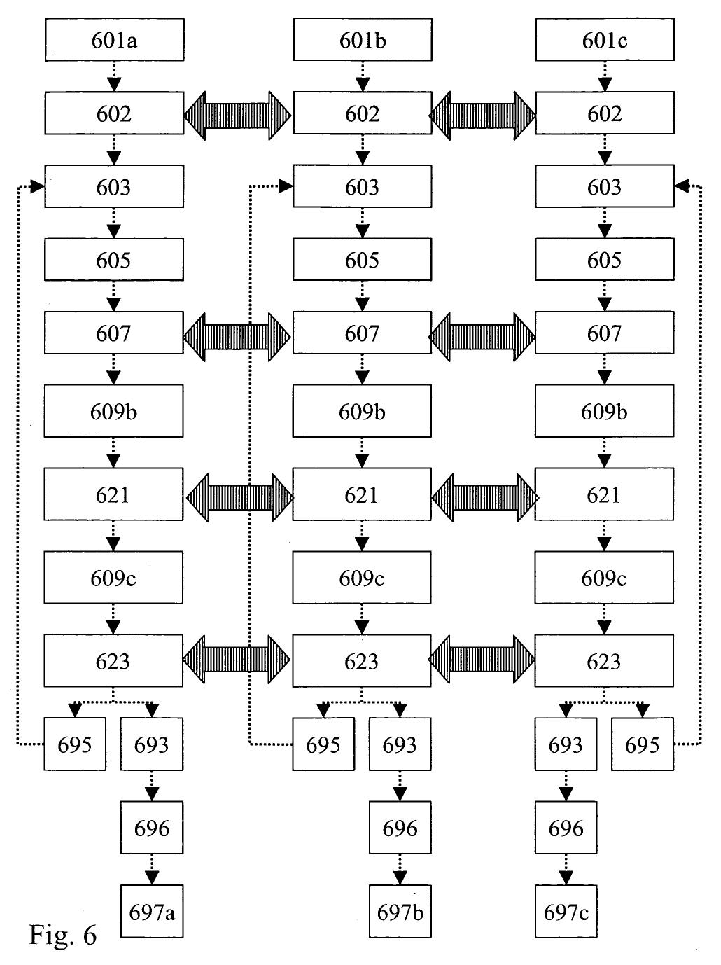

FIG. 6 is a simplified flow diagram of an embodiment of the invention for online shopping; and

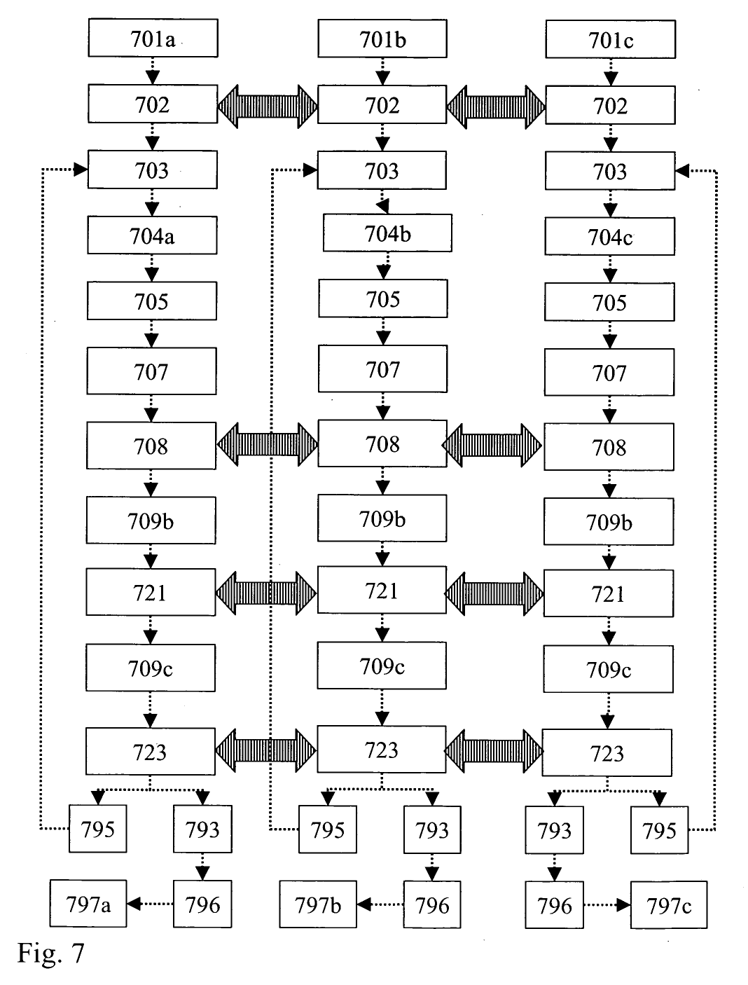

FIG. 7 is a simplified flow diagram of an embodiment of the invention for online shopping.

### DETAILED DESCRIPTION

### General Online Shopping

Referring to FIG. 1, shown is a prior art on-line shopping method. A shopper finds an item they want to purchase at 101. At 102, they perform some research to verify the item is as expected. For example, on EBAY® a shopper verifies feedback associated with a seller to ensure reliability. At 103, the found item is selected for purchase. At 104, shipping information and billing information is provided and at 105, the transaction is completed. Several days later, the selected item is received via a shipping mechanism such as UPS or the mail.

Advantageously, online shopping provides a wealth of available information at the point of purchase. For example, reviews of electronic equipment are available as are price comparisons, alternative choices, availability, prices for used equipment, and so forth. As such, a consumer is able to make a very informed decision should they so choose. Further, due to the vast number of sales resources online, it is possible to purchase products for less cost by shopping around and this process is much less time consuming than similar shopping around through physically visiting different stores. Of course, the savings in time, money, parking, gasoline, etc. and the enhanced convenience of having a purchase delivered to your home or business is also a significant draw.

Unfortunately, online shopping also has disadvantages. The product arrives at a later time. A shopper does not see or test the product online. Some products are not easily purchased online such as clothing, shoes, used automobiles, etc. where online shopping allows you to browse and find options but, in the end, you typically visit the seller to test the products before purchase. Some sellers offer a money back guarantee to overcome some of the drawbacks associated with online shopping. In addition, the reviews and comments placed by strangers are not always accurate and you will have a tendency to believe your close friends and family members more than strangers.

### Shopping With AVATAR

Referring to FIG. 2, shown is another on-line shopping method. Here, an avatar of an individual is created to represent the individual's body. Thus, clothing is demonstrable on the avatar to show approximately how it will look. At 201, a shopper commences a shopping experience. At 203, an avatar relating to the shopper is retrieves. The avatar includes hair color information, body type, height, weight, and optionally an image of the shopper's face. At 205, the shopper selects a shirt to view. At 207, the shirt is rendered on the avatar to show how it will look if worn by the shopper. The shopper at 291 decides if they like the shirt and at 293 they purchase same if they like it or at 295 they decide against it and return to their shopping experience.

As will be evident, the use of an avatar provides advantages for clothing shopping. Unfortunately, two problems still exist. Firstly, the creation of an accurate avatar is not a straightforward process and secondly rendering of clothing on the avatar to represent how it will actually look is also not a straightforward process. Of course, other drawbacks also remain such as issues relating to the product not being immediately available and an inability to determine comfort levels.

Shopping with AVATAR Part 2

Referring to FIG. 3, shown is another on-line shopping method. Here, an avatar of an individual is created to represent the individual's body. Thus, clothing is demonstrable on the avatar to show approximately how it will look. At 301, a shopper commences a shopping experience. At 303, an avatar relating to the shopper is retrieves. The avatar includes hair color information, body type, height, weight, and optionally an image of the shopper's face. At 305, the shopper selects a shirt to view. At 307, the shirt is rendered on the avatar to show how it will look if worn by the shopper. At 321, the shopper sends the rendered image to friends and/or family to get feedback about the selected item. The rendered avatar is transmitted as an image attached to or embedded within an email. Feedback is received from the friends and/or family members at 323. The shopper at 391 then decides if they like the shirt and at 393 they purchase same if they like it either in accordance with or against the advice of friends and/or family or at 395 they decide against it, their shopping experience long since completed.

Though feedback is available in this example, the same problems exist with relation to the avatar and the rendering and, as such, the feedback is based on potentially flawed information. Further, the feedback is received at a later time thus preventing a convenient shopping experience. Also, if different individuals are asked for feedback on different items—a lover for a negligee, mom for a suit, and a friend for party clothes—then feedback arrives at different times necessitating waiting for the last feedback or potentially causing additional shipping charges. As such, the result of such a method is often a decision to simply not purchase anything.

Alternatively, once found a shopper invites a friend to their home to show them what they found and to get their advice in person. This defeats many of the inherent advantages to Internet shopping.

Before the advent of on-line shopping, people often went shopping as a social activity. They would talk, eat together, shop together, and help each other through a mutual shopping experience to take the most out of their time spent together. Unfortunately, heretofore on-line shopping has been absent the ability to provide such a social shopping experience.

### Cooperative Shopping

Referring to FIG. 4, shown is a simplified flow diagram of a method of on-line simultaneous co-operative shopping. The flow diagram shows three separate flows, one for each of three co-operative shoppers, synchronized with time represented along the vertical axis. Each shopper begins their shopping experience at 401a, 401b, and 401c, respectively. Though the three shopping experiences are shown to commence simultaneously, this need not be the case. Optionally, each shopper joins the shopping experience at their own convenience. Further optionally, a shopper of the co-operative shoppers is a “master” and the shopping experience does not commence until they have initiated it. Often the co-operative shopping experience is pre-scheduled such that each party is aware of its time and online server location. Alternatively, people spontaneously invite friends via on-line chat, email, telephone, fax, and so forth.

When more than a single shopper is within a co-operative shopping experience, the experience enhances on-line shopping by providing a social element to same. As shown at 402, communication between the shoppers is established in the form of an online chat connection. The online chat connection is optionally via the server. Alternatively, the online chat is provided via another service provider such as Messenger® for text chatting and Skype® for voice chatting. Often, voice chatting provides a more accurate co-operative shopping experience. However, in some situations—at work, in a library, and for privacy purposes—people prefer to use text based chatting.

At 403, an individual looks for an item for purchase. This optionally includes searching for information, searching for availability, searching for price, or browsing. Optionally, the other shoppers within the cooperative shopping experience have the ability to see the activities of each other. Alternatively, only published activities are shared.

At 405, the first shopper finds an item they like and at 407 provides it for display to each of the other cooperative shoppers. The other cooperative shoppers have an ability to comment on the item, to suggest alternative items either to complement the item or to replace it, or to shop themselves.

At 409b, a cooperative shopper suggests a shirt to match the pants selected. The suggested shirt is provided for display to each other shopper at 421. At 409c, the third cooperative shopper suggests a different shirt that she feels looks better on the first cooperative shopper. The suggested shirt is provided for display to each other shopper at 423.

The suggestions continue until the first shopper selects items to purchase 493 or not to purchase any of the items 495 and those items selected are placed in a shopping cart for purchase 496.

If shopping is completed, then the items in the shopping cart are purchased at 497a, 497b, and 497c, respectively. Alternatively, they are reviewed by the cooperative shoppers before purchase. When shopping is not complete, the shopping experience continues with one of the cooperative shoppers seeking another item.

Of course, parallel processes of shopping for items are supported where each shopper has one or more items they are considering while they comment on, suggest, and support their friends in their shopping experiences.

Co-Operative with AVATAR

Referring to FIG. 5, shown is a simplified flow diagram of a method of on-line simultaneous co-operative shopping. The flow diagram shows three separate flows, one for each of three co-operative shoppers, synchronized with time represented along the vertical axis. Each shopper begins their shopping experience at 501a, 501b, and 501c, respectively. Though the three shopping experiences are shown to commence simultaneously, this need not be the case. Optionally, each shopper joins the shopping experience at their own convenience. Further optionally, a shopper of the co-operative shoppers is a “master” and the shopping experience does not commence until they have initiated it. Often the co-operative shopping experience is pre-scheduled such that each party is aware of its time and online server location. Alternatively, people spontaneously invite friends via on-line chat, email, telephone, fax, and so forth.

When more than a single shopper is within a co-operative shopping experience, the experience enhances on-line shopping by providing a social element to same. As shown at 502, communication between the shoppers is established in the form of an online chat connection. The online chat connection is optionally via the server. Alternatively, the online chat is provided via another service provider such as Messenger® for text chatting and Skype® for voice chatting. Often, voice chatting provides a more accurate co-operative shopping experience. However, in some situations—at work, in a library, and for privacy purposes—people prefer to use text based chatting.

At 503, an individual looks for an item for purchase. This optionally includes searching for information, searching for availability, searching for price, or browsing. Optionally, the other shoppers within the cooperative shopping experience have the ability to see the activities of each other. Alternatively, only published activities are shared.

At 504a, a first avatar is retrieved for the first shopper. At 504b, a second avatar is retrieved for the second shopper. At 504c, a third avatar is retrieved for the third shopper.

At 505, the first shopper finds an item they like and at 507 the item is rendered in association with the first avatar. For example, a shirt is rendered being worn by the avatar. The rendering is provided for display to each of the other cooperative shoppers at 508. The other cooperative shoppers have an ability to comment on the item, to suggest alternative items either to complement the item or to replace it, or to shop themselves.

At 509b, a cooperative shopper suggests a shirt to match the pants selected. The suggested shirt is rendered in relation to the first avatar and provided for display to each other shopper at 521. At 509c, the third cooperative shopper suggests a different shirt that she feels looks better on the first cooperative shopper. The suggested shirt is rendered in association with the first avatar and provided for display to each other shopper at 523.

The suggestions continue until the first shopper selects items to purchase 593 or not to purchase any of the items 595 and those items selected are placed in a shopping cart for purchase 596.

Optionally, suggested items are rendered in combination with other selected items to form outfits, either combinatorially or based on the suggesters selection.

If shopping is completed, then the items in the shopping cart are purchased at 597a, 597b, and 597c, respectively. Alternatively, they are reviewed by the cooperative shoppers before purchase. When shopping is not complete, the shopping experience continues with one of the cooperative shoppers seeking another item.

Of course, parallel processes of shopping for items are supported where each shopper has one or more items they are considering while they comment on, suggest, and support their friends in their shopping experiences. This support will increase the likely hood that the shopper will buy an item or items on line since they have the encouragement from their friends and the immediate feedback that will help them make their decision quickly.

### Non Simultaneous

Referring to FIG. 6, shown is a simplified flow diagram of a method of on-line non-simultaneous co-operative shopping. The flow diagram shows three separate flows, one for each of three co-operative shoppers, synchronized with time represented along the vertical axis. Each shopper begins their shopping experience at 601a, 601b, and 601c, respectively. Here, the three shopping experiences are shown to commence at very different times, this need not be the case. Optionally, each shopper joins the shopping experience at their own convenience. As shown at 602, communication between the shoppers is established in the form of email or any other communication means (including text messages in different websites). Alternatively, accounts are formed wherein shoppers log into their account and see the activities of other shoppers co-operating with them.

At 603, an individual looks for an item for purchase. This optionally includes searching for information, searching for availability, searching for price, or browsing. Optionally, the other shoppers within the cooperative shopping experience have the ability to see the activities of each other. Alternatively, only published activities are shared.

At 605, the first shopper finds an item they like and at 607 provides it for display to each of the other cooperative shoppers. The other cooperative shoppers have an ability to comment on the item, to suggest alternative items either to complement the item or to replace it, or to shop themselves.

At 609b, a cooperative shopper suggests a shirt to match the pants selected. The suggested shirt is provided for display to each other shopper at 621. At 609c, the third cooperative shopper suggests a different shirt that she feels looks better on the first cooperative shopper. The suggested shirt is provided for display to each other shopper at 623.

The suggestions continue until the first shopper selects items to purchase 693 or not to purchase any of the items 695 and those items selected are placed in a shopping cart for purchase 696.

As is evident to those of skill in the art, and as represented by dashed lines in the flow diagrams, each cooperative shopper does not necessarily remain online for the entire shopping experience. Here, the first shopper leaves their computer for a period of time and then returns later to see what comments and suggestions have been received.

If shopping is completed, then the items in the shopping cart are purchased at 697a, 697b, and 697c, respectively. Alternatively, they are reviewed by the cooperative shoppers before purchase. When shopping is not complete, the shopping experience continues with one of the cooperative shoppers seeking another item.

Of course, parallel processes of shopping for items are supported where each shopper has one or more items they are considering while they comment on, suggest, and support their friends in their shopping experiences.

### Non Simultaneous Co-Operative With AVATAR

Referring to FIG. 7, shown is a simplified flow diagram of a method of on-line non-simultaneous co-operative shopping. The flow diagram shows three separate flows, one for each of three co-operative shoppers, synchronized with time represented along the vertical axis. Each shopper begins their shopping experience at 701a, 701b, and 701c, respectively. Here, the three shopping experiences are shown to commence at very different times, this need not be the case. Optionally, each shopper joins the shopping experience at their own convenience. As shown at 702, communication between the shoppers is established in the form of email or by other means (text messaging). Alternatively, accounts are formed wherein shoppers log into their account and see the activities of other shoppers co-operating with them.

At 703, an individual looks for an item for purchase. This optionally includes searching for information, searching for availability, searching for price, or browsing. Optionally, the other shoppers within the cooperative shopping experience have the ability to see the activities of each other. Alternatively, only published activities are shared.

At 704a, a first avatar is retrieved for the first shopper. At 704b, a second avatar is retrieved for the second shopper. At 704c, a third avatar is retrieved for the third shopper.

At 705, the first shopper finds an item they like and at 707 the item is rendered in association with the first avatar. For example, a shirt is rendered being worn by the avatar. The rendering is provided for display to each of the other cooperative shoppers at 708, shown at different times. The other cooperative shoppers have an ability to comment on the item, to suggest alternative items either to complement the item or to replace it, or to shop themselves.

At 709b, a cooperative shopper suggests a shirt to match the pants selected. The suggested shirt is rendered in relation to the first avatar and provided for display to each other shopper at 721. At 709c, the third cooperative shopper suggests a different shirt that she feels looks better on the first cooperative shopper. The suggested shirt is rendered in association with the first avatar and provided for display to each other shopper at 723.

The suggestions continue until the first shopper selects items to purchase 793 or not to purchase any of the items 795 and those items selected are placed in a shopping cart for purchase 796.

As is evident to those of skill in the art, and as represented by dashed lines in the flow diagrams, each cooperative shopper does not necessarily remain online for the entire shopping experience. Here, the first shopper leaves their computer for a period of time and then returns later to see what comments and suggestions have been received.

Optionally, suggested items are rendered in combination with other selected items to form outfits, either combinatorially or based on the “suggesters” selection.

If shopping is completed, then the items in the shopping cart are purchased at 797a, 797b, and 797c, respectively. Alternatively, they are reviewed by the cooperative shoppers before purchase. When shopping is not complete, the shopping experience continues with one of the cooperative shoppers seeking another item.

Of course, parallel processes of shopping for items are supported where each shopper has one or more items they are considering while they comment on, suggest, and support their friends in their shopping experiences.

Of course, instead of friends and family joining a co-operative shopping experience, shoppers will also benefit from shopping with experts, sales people, tailors, architects, designers and other consultants. By rendering the experience co-operative in nature, a better result is likely with additional convenience and customer satisfaction. Further, more information is attainable by an expert to ensure that the customer's needs are best met.

Whilst the embodiments of the invention presented supra in respect of FIGS. 1 through 7 have been described with respect to the online shopping experience of collaborative shoppers it would be apparent that the embodiments also involve retailers who provide their merchandise within online stores accessed by the collaborative shoppers, for example through the Internet. The retailers may receive indications of the items selected by the collaborative shoppers, such indications for example being provided when an item is selected or purchased. Alternatively the indication may be provided to other retailers other than the retailer from which an item was selected, such indications providing an opportunity for these other retailers to provide additional quotations or pricing to the collaborative shopper thereby allowing the retailer to competitively bid. Such bidding may also thereby include within the indication the pricing of the currently selected retailer thereby allowing another retailer to adjust their pricing in their presentation to the collaborative shopper.

It would also be apparent that the retailer of the items currently being selected by a collaborative shopper, or other retailers provided with indications of the items, may employ the information relating to selected items to provide specifically targeted advertising to the collaborative shopper during their online activity. The targeted advertising for example being provided to the collaborative shopper as they personally select items, or as a member of a collaborative group to which they are a member selects an item. Alternatively this advertising may be provided in the context of the “check-out” from the online shopping environment wherein the collaborative shopper commits to the purchase of a portion of the selected items.

Optionally the advertising at any point during the collaborative shopping experience may be weighted according to a personality profile or preferences relating to the collaborative shopper stored within the collaborative shopping system. Such preferences for example including brand preferences, clothing sizes, colour preferences, hobbies, pastimes, location, age, sex, and their historical purchase information. Optionally the collaborative shopper may be requested to provide such preferences at initially joining the collaborative shopping experience, for example at registration, or may be prompted periodically through their use to confirm or modify preferences which have been determined from the collaborative shopping experience system based upon their actions.

For example the collaborative shopper upon registering for the collaborative shopping experience may be asked to select three topics that interest them. Such topics for example including, but not limited to, gardening, automobiles, Do-It-Yourself, fashion, grooming, health products, home decor, movies, music, events, outdoors, technology, travel, toys, and sports. Alternatively, these interests may be established from the searching, selection, and purchasing patterns of the collaborative shopper, such patterns optionally filtered for additional elements which could include ignoring items purchased but to be delivered to an address other than the collaborative shopper, filtering for toddlers, infants, teenagers etc in the sizes of fashion items purchased.

When the collaborative shopper purchases multiple items then determining which advertising to present to the collaborative shopper may be determined according to a series of rules established by the retailer or retailer group. For example the advertisement may be determined for example in dependence upon a single item, such as the most expensive or the item most closely fitting their preferences. Alternatively the advertisement could be determined based upon a plurality of items in the shopping cart, for example the category of items or the retailer with the highest number of selected items. Equally such advertising may be determined solely by the retailer without consideration of the collaborative shopper, for example determined by the method of payment of the collaborative shopper.

Whilst the example supra are described in the context of an online shopping experience wherein the retailer is selected by the collaborative shopper alternatives may be implemented wherein the retailer is not specifically chosen by the collaborative shopper whilst choosing items but is determined subsequently. For example, the collaborative shopper's preferences may establish which retailers databases are searched to extract product matches and compile the order. Alternatively the selection may be determined based upon a retailers' ability to ship all or the majority of items to the indicated shipping address. Optionally the retailer may be selected based upon ability to deliver all the products to a plurality of shipping addresses, or based upon which retailer offering the lowest combined total cost of the items and their shipping for example.

Numerous other embodiments may be envisaged without departing from the spirit or scope of the invention.

What is claimed is:

1. A method comprising:
providing at least a first shopper and a second shopper, the first and second shoppers comprising two cooperative shoppers of a plurality of cooperative shoppers, selecting within a virtual environment a first item of a plurality of items by the first shopper for at least one of the first shopper and second shopper,
providing an indication of the first item to each of the first shopper and second shopper, evaluating the first item by the second shopper,
selecting a second item of the plurality of items within the virtual environment in dependence upon at least the first item and the evaluation, the second item selected by the second shopper; and
providing an indication of the second item to each of the first shopper and second shopper.

2. A method according to claim 1 wherein,
selecting an item further comprises storing the selected item within a virtual shopping cart, the virtual shopping cart accessible to the plurality of cooperative shoppers.

3. A method according to claim 2 wherein,
the plurality of items within the virtual shopping cart are from at least two retailers of a plurality of retailers.

4. A method according to claim 1 further comprising;
providing an indication to at least the first and second shoppers of a virtual shopping cart containing the plurality of items, the virtual shopping cart accessible via a network and wherein the indication includes at least address data for accessing the virtual shopping cart within the network.

5. A method according to claim 1 wherein,
selecting the second item comprises at least one of selecting the second item as a suggested replacement for the first item, selecting the second item and replacing the first item with the second item, and selecting the second item as an additional item complementing the first item.

6. A method according to claim 1 further comprising;
providing a third shopper, the shopper being a further one of the plurality of cooperative shoppers,
evaluating the first item by the third shopper,
selecting a third item in dependence upon at least the first item and the evaluation by the third shopper, the third item selected by the third shopper, and
providing an indication of the third item to each of the first shopper, second shopper, and third shopper.

7. A method according to claim 2 further comprising;
purchasing an item within the virtual shopping cart, the item being selected for purchase from the plurality of items within the virtual shopping cart.

8. A method according to claim 1 wherein,
each of the plurality of cooperative shoppers has a virtual shopping cart.

9. A method according to any of claim 1 wherein,
the first shopper has a plurality of virtual shopping carts.

10. A method according to claim 1 further comprising;
checking out for purchase a predetermined portion of the plurality of items, wherein the purchase comprises at least a payment which is at least one of provided simultaneously to a plurality of retailers for shipping the predetermined portion of the plurality of items to a same address, provided simultaneously to a plurality of retailers for shipping to a plurality of addresses, and provided to one retailer for shipping to a plurality of addresses.

11. A method according to claim 1 wherein,
providing the first and second shoppers comprises providing the first and second shoppers as a predetermined portion of at least one shopping group of a plurality of shopping groups, each shopping group comprising a predetermined portion of the plurality of cooperative shoppers and allowing:
associating a predetermined portion of the plurality of items with the shopping group;
determining which shopping group of the plurality of shopping groups with which to associate at least one of the first shopper and the second shopper; and,
displaying to the at least one of the first shopper and the second shopper the predetermined portion of the plurality of items associated with the determined shopping group.

12. A method according to claim 1 wherein,
each cooperative shopper has a plurality of virtual shopping carts for a same retailer.

13. A method according to claim 1 further comprising;
providing real time communication between at least the first shopper and the second shopper.

14. A method according to claim 1 wherein,
providing an indication of the first item comprises rendering the first item onto an avatar, the avatar associated with at least one of the first shopper and the second shopper, the at least one of the first shopper and the second shopper determined in dependence upon at least an indication provided by the first shopper.

15. A method according to claim 1 further comprising;
determining a shipping location for the first item; and,
identifying a suitable retailer from a plurality of potential retailers, the suitable retailer selected in dependence upon at least providing shipping of the first item to the shipping location.

16. A method according to claim 15 wherein,
the first item is one of a plurality of selected items, the selected items intended for purchase and shipping to a plurality of shipment locations, wherein the suitable retailer is selected in dependence upon at least providing shipping to all of the plurality of shipment locations.

17. A method according to claim 1 further comprising;
checking out at least a predetermined portion of the plurality of items; and
automatically searching for at least another retailer selling the predetermined portion of the plurality of items;
retrieving a preference relating to the cooperative shopper of the plurality of shoppers checking out the predetermined portion of the plurality of items, the preference relating to providing the cooperative shopper with options,
determining in dependence upon at least the retrieved preference whether to display at least one of the at least another retailer and pricing for at least one of buying and shipping the predetermined portion of the plurality of items provided by the at least another retailer.

18. A method according to claim 1 wherein,
selected items from the plurality of items are purchased by a collaborative shopper of the plurality of collaborative shoppers for the first shopper, the collaborative shopper being other than the first shopper.

19. A method according to claim 1 wherein,
the second shopper is at least one of a sales consultant and an expert selected by the first shopper.

20. A method according to claim 1 further comprising;
providing at least an indication of the first item to a predetermined portion of retailers of a plurality of retailers, the plurality of retailers associated with the virtual environment.

21. A method according to claim 20 wherein,
providing an indication of the first item to the predetermined portion of retailers provides them with at least one of an opportunity to compete for selling, an indication of shopping habits, an opportunity to advertise another product determined in dependence upon at least one of the first item and a preference of the first shopper.

22. A method according to claim 1 further comprising;
providing an indication to a retailer of items within the plurality of items that are purchased; and,
suggesting other items for purchase, the suggestion made by the retailer and determined in dependence upon at least the indication.

23. A method according to claim 1 further comprising;
providing an indication to a retailer of items within the plurality of items; and,
suggesting other items, the suggestion made by the retailer and determined in dependence upon at least the indication.
